(19) United States
(12) Patent Application Publication
(10) Pub. No.: US 2012/0194921 A1
(43) Pub. Date: Aug. 2, 2012

(54) OPTICAL SYSTEM FOR CAMERA

(75) Inventors: Philho JUNG, Gyeonggi-do (KR); Duckhun Kim, Gyeonggi-do (KR)

(73) Assignee: SAMSUNG ELECTRO-MECHANICS CO., LTD., Suwon (KR)

(21) Appl. No.: 13/350,055

(22) Filed: Jan. 13, 2012

(30) Foreign Application Priority Data
Jan. 28, 2011 (KR) 10-2011-0008823

(51) Int. Cl. G02B 13/04; G02B 13/18

(52) U.S. Cl. 359/715; 359/753; 359/740

(57) ABSTRACT

Provided is an optical system for a camera capable of realizing a wide view angle. The optical system for a camera includes a first lens having a negative refractive index and a convex meniscus shape with respect to an object; a second lens having a negative refractive index; a third lens having a positive refractive index and an object-side convex surface with respect to the object; and a fourth lens having a positive refractive index and an image-side convex surface with respect to an image surface,
wherein the following Conditional Expression is satisfied:

0.5<v1/v2<1.2 [Conditional Expression 1]
here,
   v1: an Abbe value of the first lens, and
   v2: an Abbe value of the second lens.

### CROSS-REFERENCE TO RELATED APPLICATIONS

This application claims the benefit of Korean Patent Application No. 10-2011-0008823 filed with the Korea Intellectual Property Office on Jan. 28, 2011, the disclosure of which is incorporated herein by reference.

### BACKGROUND OF THE INVENTION

1. Field of the Invention

The present invention relates to an optical system for a camera, and more particularly, to an optical system for a camera capable of realizing a wide angle using only four lenses and reducing a price of the optical system using plastic lenses.

2. Description of the Related Art

In recent times, camera modules are mounted in mobile communication devices such as a mobile terminal, a personal digital assistant (PDA) and a smart phone, and personal computers such as a notebook computer, and automobiles, to photograph or transmit an image and talk on video telephone. Further, various new services using images photographed through the camera modules are being developed.

In an optical system constituted by a lens group mounted in such a camera module, miniaturization, light weight and low cost of the optical system are required. In addition, as a pixel size of an image sensor constituted by a charge coupled device (CCD) and a complementary metal-oxide semiconductor (CMOS) is reduced, an optical system having high resolution is needed.

In particular, when the optical system is applied to an automobile or a closed circuit television (CCTV), the optical system having a wide angle is required to obtain a wide range of image information, and the optical system must be designed to provide high brightness to easily distinguish an object to be photographed from a dark environment.

In order to maintain the high resolution and wide angle of the optical system, conventionally, eight sheets of lenses must be used, and the optical system may be constituted by glass lens having high optical transmittance and refractive index. However, due to characteristics of the optical systems mounted in mobile communication devices, automobiles and CCTVs, the conventional design of the optical system cannot easily satisfy conditions of miniaturization and low cost.

Therefore, while the optical system mounted in the mobile communication device must use the plastic lens that can be easily formed to reduce the size and manufacturing cost and the number of lenses must be reduced, since the plastic lens having lower optical performance than a glass lens is used, the optical performance cannot be satisfies by the conventional design of the optical system and reduction in number of lenses may decrease a degree of freedom in design of the optical system.

In addition, as the number of lenses constituting the optical system is increased, the entire length of the optical system may also be increased to remarkably decrease the optical performance.

### SUMMARY OF THE INVENTION

The present invention has been invented in order to overcome the above-described problems and it is, therefore, an object of the present invention to provide an optical system for a camera capable of realizing a wide angle using a minimum number of lenses and a compact optical system.

It is another object of the present invention to provide an optical system for a camera capable of realizing the wide angle at a low cost by constituting the optical system mainly using plastic lenses.

In accordance with one aspect of the present invention to achieve the object, there is provided an optical system for a camera including: a first lens having a negative refractive index and a convex meniscus shape with respect to an object; a second lens having a negative refractive index; a third lens having a positive refractive index and an object-side convex surface with respect to the object; and a fourth lens having a positive refractive index and an image-side convex surface with respect to an image surface.

In addition, in the optical system of the present invention, the following Conditional Expression may be satisfied with respect to chromatic aberration, and the following Conditional Expression 2 may be satisfied with respect to peripheral resolution of a wide angle:

0.5<v1/v2<1.2 [Conditional Expression 1]

here,
v1: an Abbe value of the first lens, and
v2: an Abbe value of the second lens; and

1.0<(R3+R4)/(R3−R4)<2.0 [Conditional Expression 2]

here,
R3 is an object-side radius of curvature of the second lens, and
R4 is an image-side radius of curvature of the second lens.

Further, any one surface of both surfaces of the second lens may be constituted by a non-spherical surface.

Furthermore, both surfaces of the third lens and the fourth lens may be constituted by non-spherical surfaces.

Here, the second lens, the third lens and the fourth lens, except for the first lens, may be formed of plastic lenses, and the first lens may be formed of a glass lens.

In addition, an aperture iris may be installed between the third lens and the fourth lens to block unnecessary light of light passing through the optical system.

Further, an optical filter having a cover glass coated with an infrared filter configured to block excessive infrared light included in light introduced from the exterior may be further provided between the fourth lens and an image surface.

Meanwhile, in the optical system of the present invention, the following Conditional Expression 3 may be satisfied with respect to dimension in an optical axis direction:

0.06<L23/TL<0.15 [Conditional Expression 3]

here,
L23: a distance between the second lens and the third lens, and
TL: a distance from an object-side apex of the first lens to an image surface along an optical axis;

the following Conditional Expression 4 may be satisfied with respect to a balance between refractive indexes of the non-spherical plastic lenses:

−2.1<f4/f2<−0.70 [Conditional Expression 4]

here,
f4: a focal distance of the fourth lens, and
f2: a focal distance of the second lens; and

the following Conditional Expression 5 may be satisfied with respect to a power ratio of two lenses disposed at the object-side:

2.5<f1/f2<5.0 [Conditional Expression 5]

here,
f1: a focal distance of the first lens, and
f2: a focal distance of the second lens.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a lens configuration view showing a lens arrangement of an optical system for a camera in accordance with a first exemplary embodiment of the present invention;

FIGS. 2A to 2C are views showing aberration of the optical system shown in Table 1 and FIG. 1;

FIG. 3 is a lens configuration view showing a lens arrangement of an optical system for a camera in accordance with a second exemplary embodiment of the present invention;

FIGS. 4A to 4C are views showing aberration of the optical system shown in Table 3 and FIG. 3;

FIG. 5 is a lens configuration view showing a lens arrangement of an optical system for a camera in accordance with a third exemplary embodiment of the present invention; and

FIGS. 6A to 6C are views showing aberration of the optical system shown in Table 5 and FIG. 5.

### DETAILED DESCRIPTION OF THE PREFERABLE EMBODIMENTS

Hereinafter, an optical system for a camera of the present invention will be described in detail with reference to the accompanying drawings. The following embodiments are provided as examples to fully convey the spirit of the invention to those skilled in the art.

Therefore, the present invention should not be construed as limited to the embodiments set forth herein and may be embodied in different forms. And, the size, thickness and shape of lenses may be overdrawn in the drawings for the convenience of explanation. In particular, in the lens configuration views, spherical or non-spherical shapes of the lenses are not limited thereto but are exemplarily illustrated.

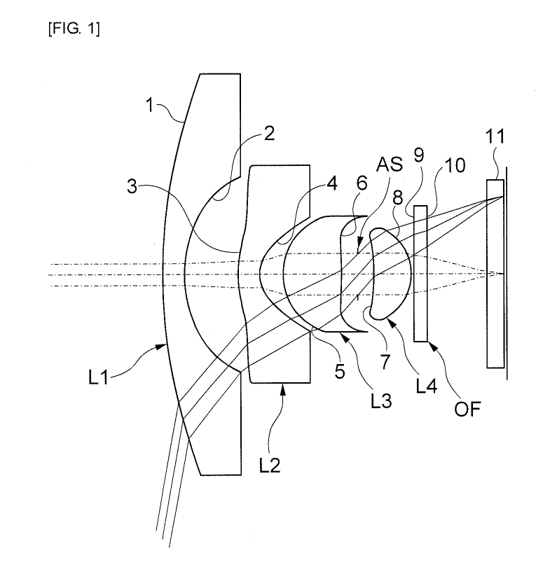

First, FIG. 1 is a lens configuration view showing a lens arrangement of an optical system for a camera in accordance with a first exemplary embodiment of the present invention. As shown in FIG. 1, the optical system for a camera in accordance with the present invention may include a first lens L1 having a convex meniscus shape with respect to an object and a negative refractive index, a second lens L2 having a negative refractive index, a third lens L3 having an object-side convex surface with respect to the object and a positive refractive index, and a fourth lens L4 having an image-side convex surface with respect to an image surface and a positive refractive index, in a sequence from the object, wherein an aperture iris (AS) is installed between the third lens L3 and the fourth lens L4.

In addition, an optical filter OF constituted by an infrared filter for blocking excessive infrared light of light passing through the optical system or a cover glass coated with the infrared filter may be installed between the fourth lens L4 and an image surface 11.

In the optical system for a camera in accordance with the present invention, the iris AS may be disposed behind the third lens L3, i.e., between the third lens L3 and the fourth lens L4, to easily obtain the intensity of radiation and realize a wide view angle using four lenses.

The first lens L1 may be formed of a glass lens, and the second lens L2, the third lens L3 and the fourth lens L4, except for the first lens L1, may be formed of plastic lenses.

Here, the second lens L2 may have at least one non-spherical surface of both surfaces, and the third lens L3 and the fourth lens L4 may have both non-spherical surfaces.

The reason for providing at least one non-spherical lens of the lenses constituting the optical system in accordance with the present invention is to minimize the number of lenses that can realize a wide view angle.

Here, since the optical system of the present invention mainly mounted in a CCTV or a camera for an automobile (front or rear) requiring a wide view angle must be operated in a high or lower temperature environment that frequently exposed to the exterior, it is preferable that the optical system is constituted by a spherical glass lens that is advantageous to realize the wide view angle. However, since at least four lenses must be essentially used when the spherical lenses are used, it is difficult to realize the compact and inexpensive optical system.

Therefore, the optical system in accordance with the present invention has a technical focus in which at least one, preferably, two lenses of the lenses constituting the optical system are constituted by non-spherical plastic lenses to realize a wide view angle using a minimal number of lenses.

Meanwhile, in the optical system of the present invention, the second lens L2, the third lens L3 and the fourth lens L4 may be constituted by non-spherical plastic lenses, one surface of both surfaces of the second lens L2 may be constituted by a non-spherical surface, and both surfaces of the third lens L3 and the fourth lens L4 may be constituted by non-spherical surfaces.

In addition, a radius of curvature of an object-side surface of the second lens L2 may have a larger absolute value as it goes from an optical center axis to an outer part.

Operation effects of the following conditional expressions in the optical system of the present invention having the above-mentioned configuration will be more specifically described below.

0.5<v1/v2<1.2 [Conditional Expression 1]

Here, v1 is an Abbe value of the first lens, and v2 is an Abbe value of the second lens.

Conditional Expression 1 relates to conditions of chromatic aberration of the optical system. When the conditions are deviated from lower and upper limits of Conditional Expression 1, focus adjustment positions of wavelengths are different from each other to generate blur of a photographed image.

1.0<(R3+R4)/(R3−R4)<2.0 [Conditional Expression 2]

Here, R3 is an object-side radius of curvature of the second lens, and R4 is an image-side radius of curvature of the second lens.

Conditional Expression 2 relates to conditions of peripheral resolution of the wide view angle. When the conditions are deviated from lower and upper limits of Conditional Expression 2, a length of the optical system is increased and resolution performance at the wide view angle cannot be easily obtained.

0.06<L23/TL<0.15 [Conditional Expression 3]

Here, L23 is a distance between the second lens and the third lens, and TL is a distance from an object-side apex of the first lens to an image surface along an optical axis.

Conditional Expression 3 relates to conditions of defining dimension of the entire optical system in an optical axis direction, and miniaturizing the optical system using proportion of the distance between the second and third lenses and the entire length of the optical system, i.e., a compact size of the optical system.

That is, when the conditions are deviated from a lower limit of Conditional Expression 3, the length of the optical system is increased to make it impossible to a compact optical system. In addition, when the conditions are deviated from an upper limit, while the optical system can be miniaturized, characteristics of the image surface 11 may be deteriorated and an interval between the second and third lenses may be extremely reduced, the optical system capable of realizing a wide view angle cannot be easily configured and thus optical characteristics required in the present invention cannot be easily satisfied.

−2.1<f4/f2<−0.70 [Conditional Expression 4]

Here, f4 is a focal distance of the fourth lens, and f2 is a focal distance of the second lens.

Conditional Expression 4 relates to conditions of balancing refractive indexes of non-spherical plastic lenses disposed in the optical system of the present invention. When the conditions is deviated from a lower or upper limit of Conditional Expression 4, as a balance in refractive index between a lens having a positive refractive index and a lens having a negative refractive index is broken, a moving distance toward the image surface may be excessively increased when an external temperature varies, generating reduction in resolution performance at a fixed focus.

2.5<f1/f2<5.0 [Conditional Expression 5]

Here, f1 is a focal distance of the first lens, and f2 is a focal distance of the second distance.

Conditional Expression 5 relates to conditions of a power ratio by focal distances of the first and second lenses disposed at an object-side in the optical system of the present invention. When the conditions are deviated from a lower limit Conditional Expression 5, power of the first lens is increased and a radius of curvature is reduced to make it difficult to manufacture the optical system. In addition, when the conditions are deviated from an upper limit, power of the second lens is increased and a size of the second lens must be extremely reduced, making it difficult to constitute the optical system.

Hereinafter, the optical system of the present invention will be more specifically described through specific numerical examples.

As described above, in first to third embodiments, the optical system may include the first lens L1 having a convex meniscus shape with respect to an object and a negative refractive index, the second lens L2 having a negative refractive index, the third lens L3 having an object-side convex surface with respect to the object and a positive refractive index, and the fourth lens L4 having an image-side convex surface with respect to an image surface and a positive refractive index, in a sequence from the object, wherein the aperture iris (AS) is installed between the third lens L3 and the fourth lens L4.

A radius of curvature of an object-side surface of the second lens L2 may have a larger absolute value as it goes from an optical center axis to a peripheral part.

In addition, the second lens L2, the third lens L3 and the fourth lens L4 may be formed of plastic lenses. Here, any one surface of both surfaces of the second lens L2 may be constituted by a non-spherical surface, and both surfaces of the third lens L3 and the fourth lens L4 may be constituted by non-spherical surfaces.

Meanwhile, the non-spherical surfaces used in the following embodiments are obtained from known Mathematical Equation 1, which is represented by Conic constant K and non-spherical coefficients A, B, C, D, E and F. Here, “E and following numbers” represents exponential expression of 10. For example, E+02 represents 10², and E-02 represents 10⁻².

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Mathematical Equation 1 ]$$

Here,
Z: distance from apes of lens in optical axis direction
Y: distance perpendicular to optical axis
c: reciprocal number of radius of curvature (r) at apex of lens
K: Conic constant
A, B, C, D, E and F: non-spherical coefficient

### First Embodiment

The following Table 1 represents numerical examples of the first embodiment of the present invention.

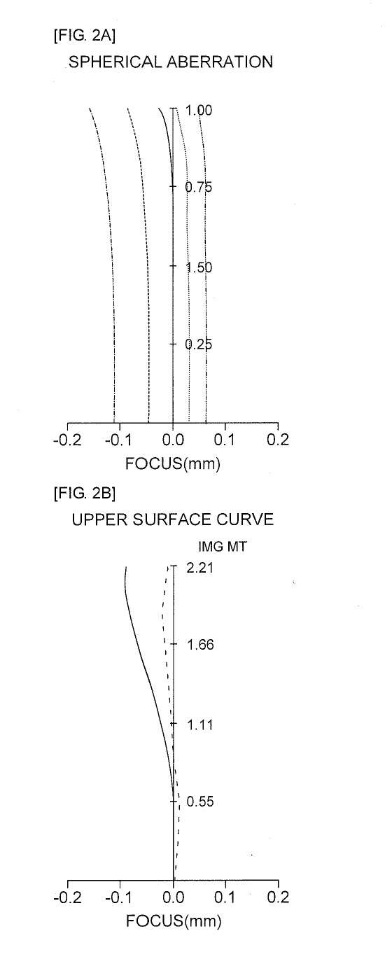

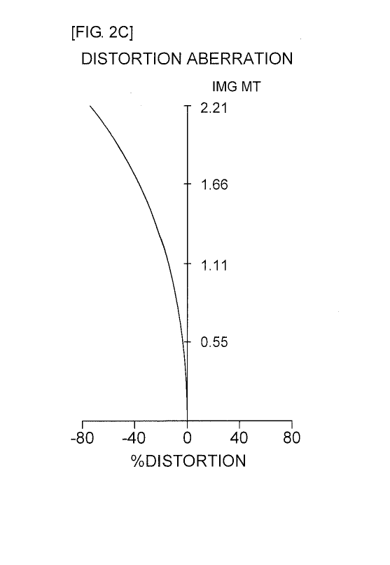

Here, FIG. 1 is a lens configuration view showing a lens arrangement of an optical system for a camera in accordance with a first exemplary embodiment of the present invention, and FIGS. 2A to 2C are views showing spherical aberration and distortion aberration of the optical system shown in Table 1 and FIG. 1.

In the first embodiment, a view angle is 162°, a distance TL from an object-side surface 1 to an image-side surface of the first lens L1 is 9.61 mm, and an effective focal distance f of the entire optical system is 1.4 mm. In addition, the second lens L2, the third lens L3 and the fourth lens L4 are constituted by plastic lenses.

Further, in focal distances of the respective lenses employed in the first embodiment, f1 is −6.870, f2 is −2.050, f3 is 2.242, and f4 is 2.458.

TABLE 1

| | Radius of | Thickness or | Refractive | Abbe value | |
|---|---|---|---|---|---|
| Surface No. | Curvature (R) | distance (t) | index (n) | (v) | Note |
| 1 | 15.796 | 0.60 | 1.60 | 38.0 | First lens |
| 2 | 3.252 | 1.50 | | | |
| * 3 | 2.252 | 0.60 | 1.53 | 55.7 | Second lens |
| * 4 | 0.670 | 1.67 | | | |
| * 5 | 1.502 | 1.65 | 1.84 | 23.8 | Third lens |
| * 6 | −10.791 | 0.47 | | | |
| * 7 | 22.734 | 1.07 | 1.53 | 55.7 | Fourth lens |
| * 8 | −1.397 | 0.10 | | | |
| 9 | ∞ | 0.40 | 1.51 | 64.2 | Optical filter |
| 10 | ∞ | 1.60 | | | |

In Table 1, * marks before the surface numbers represent non-spherical surfaces. In the first embodiment, one surface of both surfaces of the second lens L2 is a non-spherical surface, and both surfaces of the third lens L3 and the fourth lens L4 are non-spherical surfaces.

Here, values of non-spherical coefficients of the first embodiment by Mathematical Equation 1 are represented in the following Table 2.

TABLE 2

| Surface | | | | | | |
|---|---|---|---|---|---|---|
| No. | K | A | B | C | D | E |
| 3 | −7.935E+00 | −2.231E−02 | 2.662E−03 | −1.16E−04 | 2.14E−04 | 0 |
| 4 | −1.373E+00 | 4.471E−02 | −1.35E−02 | −5.833E−03 | 2.408E−03 | 0 |
| 5 | −2.283E−01 | −1.254E−02 | 4.477E−03 | −5.858E−03 | 1.078E−03 | 0 |
| 6 | −1.801E+00 | 3.174E−02 | 2.043E−02 | −1.364E−02 | 6.465E−03 | 0 |
| 7 | 0 | 5.393E−02 | 5.893E−02 | −1.16E−01 | −1.729E−01 | 8.688E−02 |
| 8 | −5.068E−02 | 2.906E−02 | 8.34E−03 | −1.83E−02 | 1.132E−02 | 3.98E−03 |

### Second Embodiment

The following Table 3 represents numerical examples of the second embodiment of the present invention.

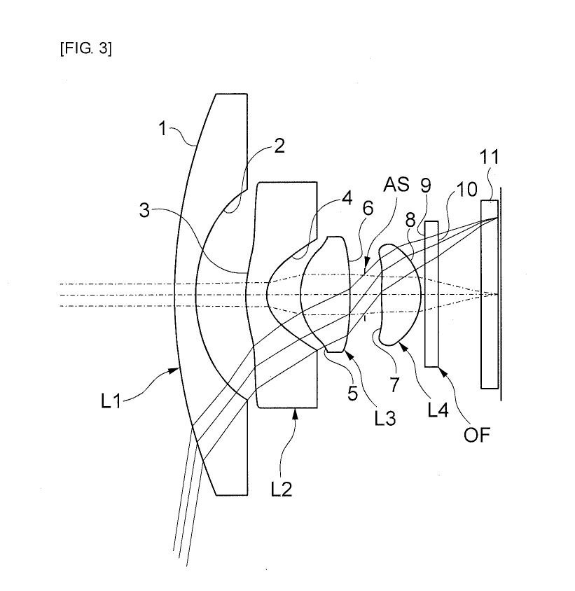

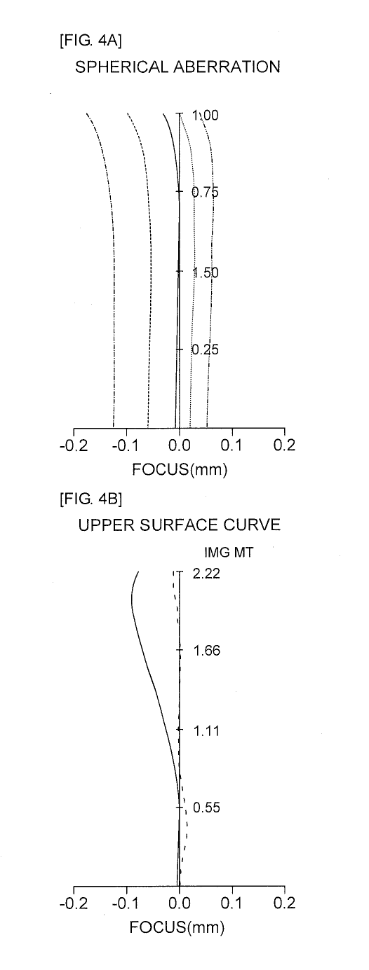

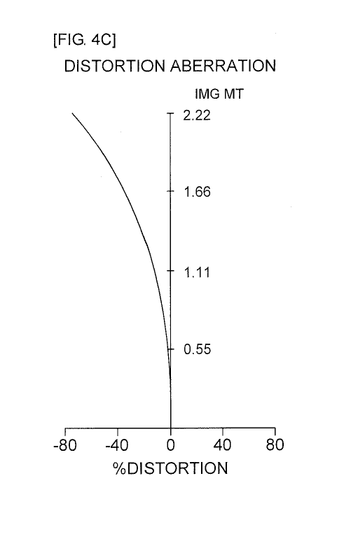

Here, FIG. 3 is a lens configuration view showing a lens arrangement of an optical system for a camera in accordance with a second exemplary embodiment of the present invention, and FIGS. 4A to 4C are views showing spherical aberration and distortion aberration of the optical system shown in Table 3 and FIG. 3.

In the second embodiment, a view angle is 162°, a distance TL from an object-side surface 1 to an image-side surface of the first lens L1 is 9.33 mm, and an effective focal distance f of the entire optical system is 1.4 mm. In addition, the second lens L2, the third lens L3 and the fourth lens L4 are constituted by plastic lenses.

Further, in focal distances of the respective lenses employed in the second embodiment, f1 is −9.174, f2 is −1.997, f3 is 2.175, and f4 is 2.731.

TABLE 3

| | Radius of | Thickness or | Refractive | Abbe value | |
|---|---|---|---|---|---|
| Surface No. | Curvature (R) | distance (t) | index (n) | (v) | Note |
| 1 | 14.252 | 0.60 | 1.60 | | First lens |
| 2 | 3.941 | 1.41 | | | |
| * 3 | 2.088 | 0.60 | 1.53 | 55.7 | Second lens |
| * 4 | 0.637 | 0.96 | | | |
| * 5 | 1.494 | 1.44 | 1.84 | 23.8 | Third lens |
| * 6 | −8.714 | 0.39 | | | |
| * 7 | 5.943 | 1.13 | 1.53 | 55.7 | Fourth lens |
| * 8 | −1.767 | 0.10 | | | |
| 9 | ∞ | 0.40 | 1.51 | 64.2 | Optical filter |
| 10 | ∞ | 1.25 | | | |

In Table 3, * marks before the surface numbers represent non-spherical surfaces. In the second embodiment, one surface of both surfaces of the second lens L2 is a non-spherical surface, and both surfaces of the third lens L3 and the fourth lens L4 are non-spherical surfaces.

Here, values of non-spherical coefficients of the second embodiment by Mathematical Equation 1 are represented in the following Table 4.

TABLE 4

| Surface | | | | | | |
|---|---|---|---|---|---|---|
| No. | K | A | B | C | D | E |
| 3 | −9.359E+00 | 2.113E−02 | 2.649E−03 | −1.26E−04 | 2.19E−06 | 0 |
| 4 | −1.507E+00 | 8.422E−02 | −2.152E−02 | −7.399E−03 | 2.525E−03 | 1.342E−04 |
| 5 | 5.339E−01 | −6.644E−03 | 8.764E−03 | −8.325E−03 | 9.496E−04 | 2.672E−04 |
| 6 | 2.912E+01 | 3.405E−02 | −6.035E−03 | −1.216E−02 | 7.283E−03 | 1.305E−03 |
| 7 | 0 | 4.249E−02 | 6.24E−02 | 1.153E−01 | −1.256E−01 | 4.346E−02 |
| 8 | −3.520E−01 | 2.819E−02 | 3.87E−03 | 1.385E−02 | 7.184E−03 | 2.67E−03 |

### Third Embodiment

The following Table 5 represents numerical examples of the third embodiment of the present invention.

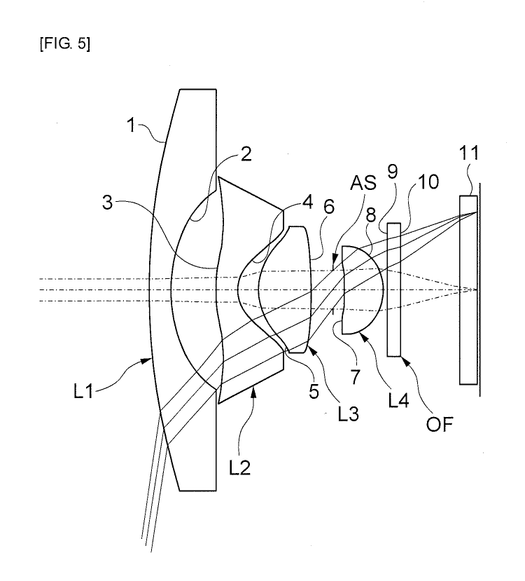

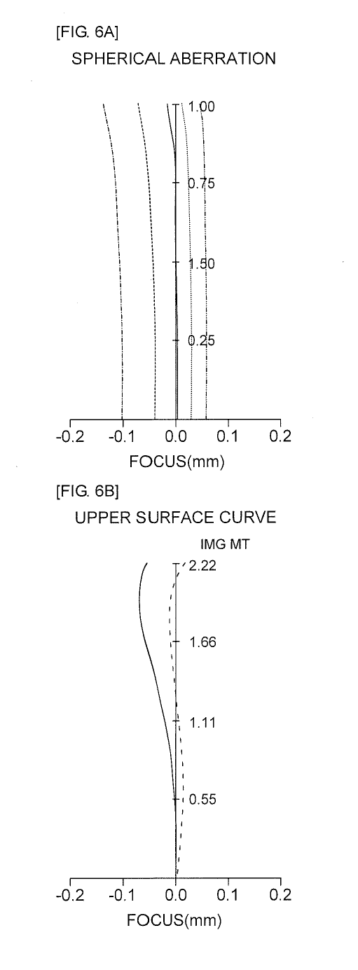

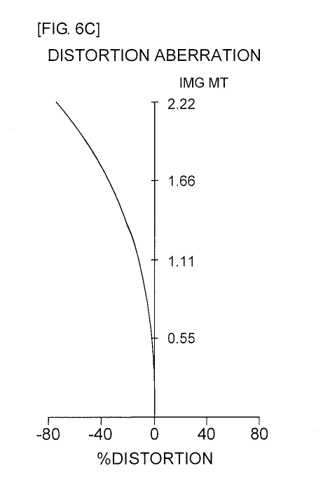

Here, FIG. 5 is a lens configuration view showing a lens arrangement of an optical system for a camera in accordance with a third exemplary embodiment of the present invention, and FIGS. 6A to 6C are views showing spherical aberration and distortion aberration of the optical system shown in Table 5 and FIG. 5.

In the third embodiment, a view angle is 162.5°, a distance TL from an object-side surface 1 to an image-side surface of the first lens L1 is 9.36 mm, and an effective focal distance f of the entire optical system is 1.4 mm. In addition, the second lens L2, the third lens L3 and the fourth lens L4 are constituted by plastic lenses.

Further, in focal distances of the respective lenses employed in the third embodiment, f1 is −7.731, f2 is −2.050, f3 is 2.323, and f4 is 2.303.

TABLE 5

| | Radius of | Thickness or | Refractive | Abbe value | |
|---|---|---|---|---|---|
| Surface No. | Curvature (R) | distance (t) | index (n) | (v) | Note |
| 1 | 19.622 | 0.60 | 1.60 | 38.0 | First lens |
| 2 | 3.744 | 1.27 | | | |
| * 3 | 2.828 | 0.60 | 1.53 | 55.7 | Second lens |
| * 4 | 0.733 | 0.60 | | | |
| * 5 | 1.725 | 1.474 | 1.84 | 23.8 | Third lens |
| * 6 | −5.872 | 0.62 | | | |
| * 7 | −14.779 | 1.10 | 1.53 | 55.7 | Fourth lens |
| * 8 | −1.223 | 0.10 | | | |
| 9 | ∞ | 0.40 | 1.51 | 64.2 | Optical filter |
| 10 | ∞ | 1.70 | | | |

In Table 5, * marks before the surface numbers represent non-spherical surfaces. In the third embodiment, one surface of both surfaces of the second lens L2 is a non-spherical surface, and both surfaces of the third lens L3 and the fourth lens L4 are non-spherical surfaces.

Here, values of non-spherical coefficients of the third embodiment by Mathematical Equation 1 are represented in the following Table 6.

TABLE 6

| Surface | | | | | | |
|---|---|---|---|---|---|---|
| No. | K | A | B | C | D | E |
| 3 | −8.545E+00 | −2.431E−02 | 2.525E−03 | −5.51E−05 | −2.93E−06 | 0 |
| 4 | 1.095E+00 | −1.484E−02 | −1.238E−02 | −1.651E−03 | 3.942E−04 | 0 |
| 5 | −6.179E−01 | 9.982E−03 | −1.511E−04 | −8.416E−04 | −6.427E−04 | 0 |
| 6 | 9.737E+00 | 2.689E−02 | 5.306E−03 | −1.099E−03 | −1.533E−04 | 0 |
| 7 | 0 | 9.437E−02 | 6.230E−02 | 7.277E−02 | 2.265E−01 | 1.500E−01 |
| 8 | 8.534E−02 | 3.251E−02 | 1.110E−02 | −2.147E−02 | 1.554E−02 | 5.53E−03 |

Meanwhile, values of Conditional Expressions 1 to 5 in the first to third embodiments are represented in the following Table 7.

TABLE 7

| | Embodiment 1 | Embodiment 2 | Embodiment 3 |
|---|---|---|---|
| Conditional | 0.68 | 0.68 | 0.68 |
| Expression 1 (v1/v2) | | | |
| Conditional | 1.84 | 1.87 | 1.70 |
| Expression 2 | | | |
| (R3 + R4)/(R3 − R4) | | | |
| Conditional | 0.070 | 0.103 | 0.064 |
| Expression 3 | | | |
| (D23/TL) | | | |
| Conditional | −1.97 | −1.36 | −1.12 |
| Expression 4 (f4/42) | | | |
| Conditional | 3.35 | 4.59 | 3.77 |
| Expression 5 (f1/f2) | | | |

In Table 7, it will be appreciated that the first to third embodiments of the present invention satisfy Conditional Expressions 1 to 5.

As can be seen from the foregoing, the optical system for a camera in accordance with the present invention includes four lenses, in which three lenses of the four lenses, except one lens, are constituted by non-spherical plastic lenses, such that a wide view angle is realized by a minimal number of lenses to configure a compact optical system and reduce manufacturing cost thereof.

In addition, the three plastic lenses of the present invention are appropriately disposed and power of the lenses according to positive and negative refractive indexes are also appropriately disposed, realizing a good image, without reduction in performance upon realization of the wide view angle due to an external temperature when the optical system is exposed to a high temperature.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. An optical system for a camera comprising:
a first lens having a negative refractive index and a convex meniscus shape with respect to an object;
a second lens having a negative refractive index;
a third lens having a positive refractive index and an object-side convex surface with respect to the object; and
a fourth lens having a positive refractive index and an image-side convex surface with respect to an image surface,
wherein the following Conditional Expression is satisfied:
0.5<v1/v2<1.2 [Conditional Expression 1]
here,
v1: an Abbe value of the first lens, and
v2: an Abbe value of the second lens.

2. The optical system for a camera according to claim 1, wherein the second lens has an absolute value of an object-side radius of curvature becoming larger from an optical axis center to a peripheral part.

3. The optical system for a camera according to claim 1, wherein the second lens and the fourth lens are constituted by plastic lenses.

4. The optical system for a camera according to claim 1, wherein any one surface of both surfaces of the second lens is constituted by a non-spherical surface.

5. The optical system for a camera according to claim 1, wherein both surfaces of the third lens and the fourth lens are constituted by non-spherical surfaces.

6. The optical system for a camera according to claim 1, wherein an aperture iris is installed between the third lens and the fourth lens to block unnecessary light of light passing through the optical system.

7. The optical system for a camera according to claim 1, wherein the following Conditional Expression 2 is satisfied with respect to peripheral resolution of a wide angle:
1.0<(R3+R4)/(R3−R4)<2.0 [Conditional Expression 2]
here,
R3 is an object-side radius of curvature of the second lens, and
R4 is an image-side radius of curvature of the second lens.

8. The optical system for a camera according to claim 1 or 7, wherein the following Conditional Expression 3 is satisfied with respect to dimension in an optical axis direction:
0.06<L23/TL<0.15 [Conditional Expression 3]
here,
L23: a distance between the second lens and the third lens, and
TL: a distance from an object-side apex of the first lens to an image surface along an optical axis.

9. The optical system for a camera according to claim 1 or 7, wherein the following Conditional Expression 4 is satisfied with respect to a balance between refractive indexes of the non-spherical plastic lenses:
−2.1<f4/f2<−0.70
here,
f4: a focal distance of the fourth lens, and
f2: a focal distance of the second lens.

10. The optical system for a camera according to claim 1 or 7, wherein the following Conditional Expression 5 is satisfied with respect to a power ratio of two lenses disposed at the object-side:
2.5<f1/f2<5.0 [Conditional Expression 5]
here,
f1: a focal distance of the first lens, and
f2: a focal distance of the second lens.
